(19) United States
(12) Patent Application Publication
(10) Pub. No.: US 2019/0390791 A1
(43) Pub. Date: Dec. 26, 2019

(54) GAS SUPPLY REGULATOR

(71) Applicant: CLESSE INDUSTRIES, COURNON D'AUVERGNE (FR)

(72) Inventors: Franck BEAUGIER, Dallet (FR); Eric FOURNIER, Saint Sylvestre Pragoulin (FR)

(73) Assignee: CLESSE INDUSTRIES, COURNON D'AUVERGNE (FR)

(21) Appl. No.: 16/451,556

(22) Filed: Jun. 25, 2019

(30) Foreign Application Priority Data
Jun. 25, 2018 (FR) 18/55668

(51) Int. Cl. F16K 31/42; G05D 16/00; G05D 7/01; F16K 37/00

(52) U.S. Cl. CPC F16K 31/42; F16K 37/0066; G05D 7/0113; G05D 16/024

(57) ABSTRACT

A gas supply regulation assembly includes at least one inlet capable of being in fluid communication with at least one gas bottle and an outlet capable of being in fluid communication with a gas-consuming appliance. The gas supply regulation assembly further includes a gas pressure detection device for detecting gas pressure in a chamber communicating with the outlet.

### CROSS-REFERENCE TO RELATED APPLICATIONS

This application claims priority to and the benefit of FR 18/55668 filed on Jun. 25, 2018. The disclosure of the above application is incorporated herein by reference.

### FIELD

The present disclosure relates to a gas supply regulator.

### BACKGROUND

The statements in this section merely provide background information related to the present disclosure and may not constitute prior art.

A gas supply regulator refers to an apparatus located between one or more gas supply bottles and one or more gas-consuming appliances, such as a cooktop.

Such a regulator may be an automatic diverter, a pressure reducer (for example as disclosed by the French patent application 11/61982 filed Dec. 20, 2011, in the name of the applicant, now published as FR2984448), or a pressure limiter. The disclosure of French patent application 11/61982 is incorporated herein in its entirety.

An automatic diverter allows automatically switching from a service gas bottle to a reserve gas bottle when the pressure of the service gas bottle drops below a predetermined threshold, so as to ensure the constant supply of a gas-consuming appliance, such as a cooktop for example.

Such an automatic diverter is installed upstream of a pressure reducer, the latter allowing to lower the pressure of the gas within a pressure range that is compatible with the operation of the gas-consuming appliance.

With traditional gas supply regulators, it can be difficult to manage the replacement of gas bottles supplying the diverter, in particular so as to avoid any supply shortage of the gas-consuming appliance, and more generally to better monitor the behavior of a gas supply regulator such as an automatic diverter, a pressure reducer, or a pressure limiter.

The present disclosure address these and other issues associated with traditional gas supply regulators.

### SUMMARY

This section provides a general summary of the disclosure and is not a comprehensive disclosure of its full scope or all of its features.

The present disclosure allows for better managing the replacement of gas bottles supplying the diverter, in particular so as to avoid any supply shortage of the gas-consuming appliance, and more generally to better monitor the behavior of a gas supply regulator such as an automatic diverter, a pressure reducer, or a pressure limiter.

The present disclosure provides a gas supply regulation assembly including at least one inlet capable of being in fluid communication with at least one gas bottle, and one outlet capable of being in fluid communication with a gas-consuming appliance, and a gas pressure detection device for detecting gas pressure in a chamber communicating with the outlet.

Due to the presence of the gas pressure detection device, useful information on the behavior of the regulation assembly can be obtained such as passage of a diverter on the reserve, a pressure reducer in an over pressure (OPSO system) or an under pressure (UPSO system) shut off, correct installation of the diverter/pressure reducer/limiter, etc.

According to other advantageous optional characteristics of the present disclosure, the regulation assembly includes a diverter of the type including at least two inlets capable of being coupled to at least two gas bottles, one outlet capable of being coupled to a gas-consuming appliance, an automatic switching device or mechanism that switches the gas supply from one of the inlets by one of the bottles to the other inlet by the other bottles when the gas supply pressure drops below a predetermined threshold.

Due to the presence of the the gas pressure detection device, it is possible to know when the automatic diverter has switched from the first gas bottle, called service bottle, to the second gas bottle, called reserve bottle.

This information can then be exploited so as to anticipate the replacement of the empty service bottle, and thus avoid any supply shortage of the gas-consuming appliance.

According to yet other advantageous optional characteristics of the present disclosure:

the gas pressure detection device includes a magnetic field measurement device for measuring the variation of a magnetic field (e.g., a Hall effect probe); and/or

the gas pressure detection device includes a flexible membrane forming one of the walls of the chamber, elastically returned in the direction of the chamber by a spring, the flexible membrane supporting a cage enclosing a magnet; the gas pressure detection device further including the magnetic field measurement device fixedly mounted relative to the body of the automatic diverter, capable of magnetically interacting with the magnet. Due to these characteristics, the relative positions of the magnet relative to the probe provide reliable information on the position of the magnet and consequently the pressure level upstream of the outlet of the automatic diverter. In the case of an automatic diverter, the information allows, in addition to detecting the passage of the gas supply from the service bottle to the reserve bottle, detecting whether the bottles are not installed, improperly installed, whether the the magnetic field measurement device is improperly installed, or whether the diverter is located close to a magnetic or magnetizable surface, capable of disturbing the signals generated by the probe. The information also allows knowing whether the support on which is mounted the probe is properly or improperly installed, or not installed at all.

According to further advantageous optional characteristics of the present disclosure:

the regulation assembly includes an electronic communication circuit connected to the magnetic field measurement device and allowing to transmit the signals generated by the magnetic field measurement device to the outside: the presence of the communication circuit allows exploiting these signals, in order to best provide the management of the gas bottles, and, where appropriate, to detect an operation or branching anomaly;

the electronic communication circuit is embedded in resin, thus allowing the circuit to operate in an ATEX environment, that is to say to avoid any risk of explosion under the effect of an electric spark, in case of gas leakage;

the electronic circuit includes a wireless communication device and a supply battery, thus allowing the electronic circuit to operate completely autonomously, wirelessly. This allows for example a provider of gas bottles to manage the supply of the providers customers by telemetry;

the magnetic field measurement device and the electronic circuit are mounted on a plate that can be optionally attached on the body of the regulation assembly, thus having a single model of a regulation assembly body, which can be equipped or not with the pressure monitoring option;

the assembly further includes a pressure reducer provided with its own gas pressure detection device; and/or

the assembly further includes a pressure limiter provided with its own gas pressure detection device.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an exploded perspective view of an automatic diverter assembly, illustrating a diverter and a detection plate that can be attached on a body of the diverter, and including a Hall effect probe and an electronic communication circuit according to the present disclosure;

FIG. 2 is a cross-sectional view taken along the plane P of FIG. 1 of the diverter in one operating position and of the detection plate, a number of diverter members are not illustrated for simplicity purposes;

FIG. 3 is a cross-sectional view taken along the plane P of FIG. 1 of the diverter in another operating position and of the detection plate, a number of diverter members are not illustrated for a simplicity purposes;

FIG. 4 is a cross-sectional perspective view taken along the plane P FIG. 1 similar to FIG. 3;

FIG. 5 is a cross-sectional perspective view of a pressure reducer in accordance with the present disclosure,

FIG. 6 is a cross-sectional perspective view of a regulation assembly including an automatic diverter similar to any of FIGS. 1 to 4 and the pressure reducer of FIG. 5; and

FIG. 7 is a cross-sectional perspective view of a regulation assembly including an automatic diverter similar to any of FIGS. 1 to 4 and a pressure limiter L according to the present disclosure.

In all of these figures, identical or similar references designate identical or similar members or set of members.

In addition, a common XYZ reference frame was represented in all of the figures, allowing to clearly understand the respective orientations of these figures relative to each other.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

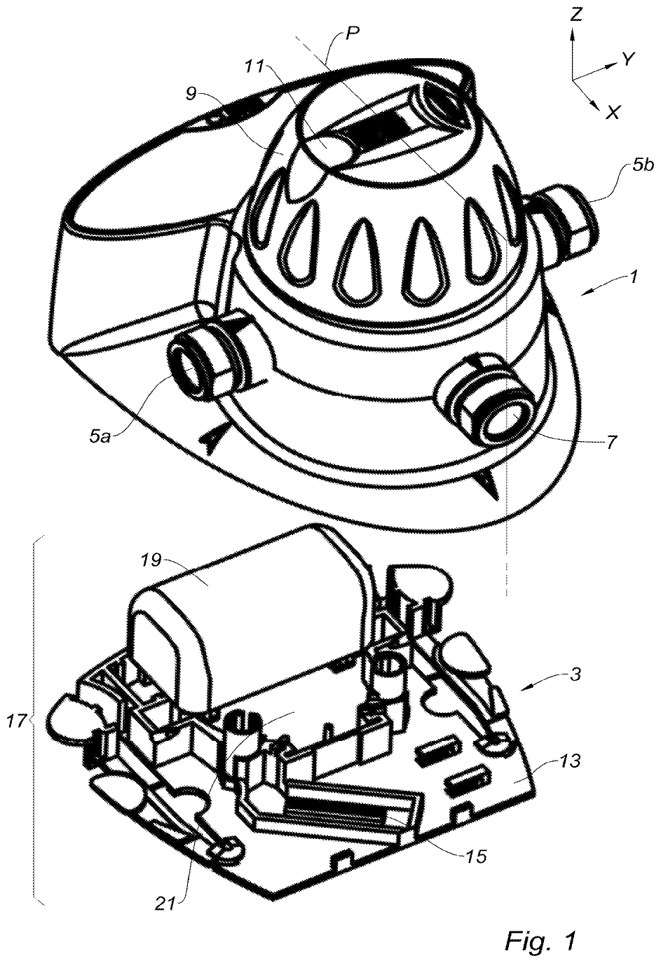

Referring now to FIG. 1, an automatic diverter is illustrated according to the present disclosure and includes an automatic diverter 1 and a detection plate 3.

The automatic diverter 1 includes gas inlets 5a and 5b, each configured to be connected to a gas supply bottle (bottles not shown).

The diverter 1 also includes a gas outlet 7 configured to supply a gas-consuming appliance.

The diverter 1 also includes a rotary knob 9 provided with an indicator 11, the indicator 11 displaying a particular color when the gas supply bottle called “service” bottle, that is to say the first bottle used, is nearly empty, and the diverter 1 has switched on the second gas bottle, called “reserve” bottle.

The particular mode of operation of such an automatic diverter 1 is part of the state of the art, and therefore will not be detailed here; in general, it includes an automatic switching device in which its operating principle and mechanism is based on a system of springs and valves, these springs being calibrated so that when the pressure of the gas leaving the service bottle drops below a predetermined threshold (typically of the order of 1.5 bars, but may take any other value), the valves change their position, allowing to switch the gas supply from the service bottle to the reserve bottle.

The detection plate 3 includes a support 13, for example formed of plastic material or of any non-magnetic material, on which are fastened a probe for measuring a magnetic field (e.g., a Hall effect probe 15) and an electronic module 17, electrically connected to the probe 15.

The module 17 includes a battery 19 and an electronic card 21. The card 21, according to one form is embedded in resin, so as to reduce any risk of explosion by an electric spark, in case of gas leakage.

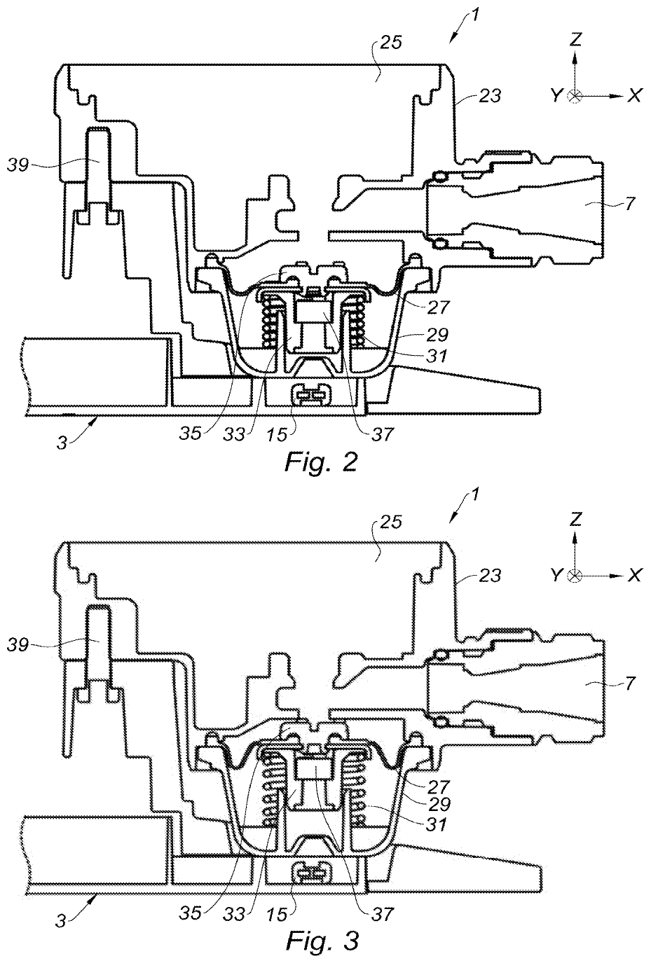

The cooperation between the detection plate 3 and the diverter 1 will be understood in the review of the appended FIGS. 2 to 4.

The body 23 of the diverter 1 includes a chamber 25 communicating with the gas outlet 7.

It is in the chamber 25 that gas arrives from either one of the service and reserve bottles. A flexible membrane 27, closing a bowl 29, is facing the chamber 25, and in communication with it.

The flexible membrane 27 is returned in the direction of the chamber 25 by a helical spring 31.

The flexible membrane 27 is connected to a cage 33 by a flange 35. In one form, the cage 33 is formed of plastic material, but especially non-magnetic material.

Inside the cage 33 there is a magnet 37, capable of magnetically interacting with the Hall effect probe 15 of the detection plate 3. In another configuration, the Hall effect probe is replaced by any other suitable electronic component configured to perform a measurement of the value of the magnetic field.

The detection plate 3 is attached on the body 23 of the diverter 1 by appropriate fastening means.

The mode of operation and the advantages of the diverter assembly which have just been described are as follows.

FIG. 2 shows the diverter assembly when it is supplied by the service gas bottle. The pressure in the chamber 25 of the body of the diverter 1 is relatively high (typically above 1.5 bar) so that the membrane 27 is in the low position in FIG. 2, that is to say that the element 37 is relatively close to the Hall effect probe 15. By measuring the magnetic field corresponding to this particular position, the Hall effect probe 15 sends to the electronic circuit 21 a signal indicating that the diverter 1 operates on the service gas bottle.

If the electronic card 21 is provided with means for communication to the outside, the information can be exported to a server. In one example, the electronic card 21 includes a wireless communication module of the Bluetooth, Wi-fi, GSM, IoT type or any other future communication system configured to export the information.

When the service bottle is nearly empty, the pressure in the chamber 25 of the body 23 of the diverter 1 decreases, and due to the device of the diverter 1 known and generally mentioned above, the gas supply of the diverter 1 switches from the service bottle to the reserve bottle.

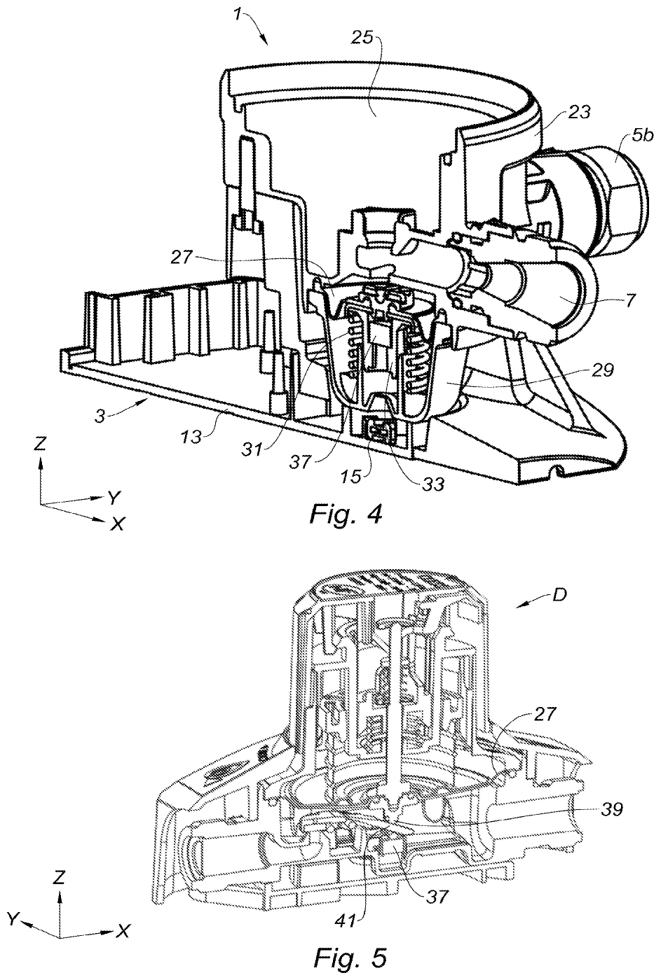

As the pressure in the chamber 25 has decreased, the flexible membrane 27 rises, as illustrated in FIGS. 3 and 4, so that the magnet 37 moves away from the probe 15.

The probe then sends the information corresponding to the electronic circuit 21, indicating that the diverter 1 has switched from the service bottle to the reserve bottle.

The information can be recovered by a provider of gas bottles, which can thus anticipate the needs of customers, and resupply them so as to avoid any gas supply shortage.

Another significant advantage of the present disclosure is that the Hall effect probe 15 allows detecting malfunctions of the diverter 1, such as an absence of gas supply, an incorrect installation of one of the bottles, or the presence a magnetic mass in the proximity of the diverter, capable of disturbing the signals sent by the Hall effect probe 15.

The probe 15 also allows verifying whether the assembly formed by the diverter 1 and the magnetic field measurement device for measuring the value of the magnetic field generated by the magnet 37, has not undergone mechanical degradation due to an external action; to do so it is sufficient to compare the values returned by the probe 15 to the installation values.

These malfunctions can be easily identified by analyzing the drift of the signals returned by the Hall effect probe 15, compared to the signals corresponding to a normal operating situation.

Of course, the present disclosure is in no way limited to the form described and shown and is merely provided as one example.

Thus, the present disclosure can also be applied to a pressure reducer D, as shown in a cross-sectional view in FIG. 5. In this case, the magnet 37 is movably secured to the finger 39 acting on the regulation lever 41, the finger 39 being in turn secured to the flexible membrane 27.

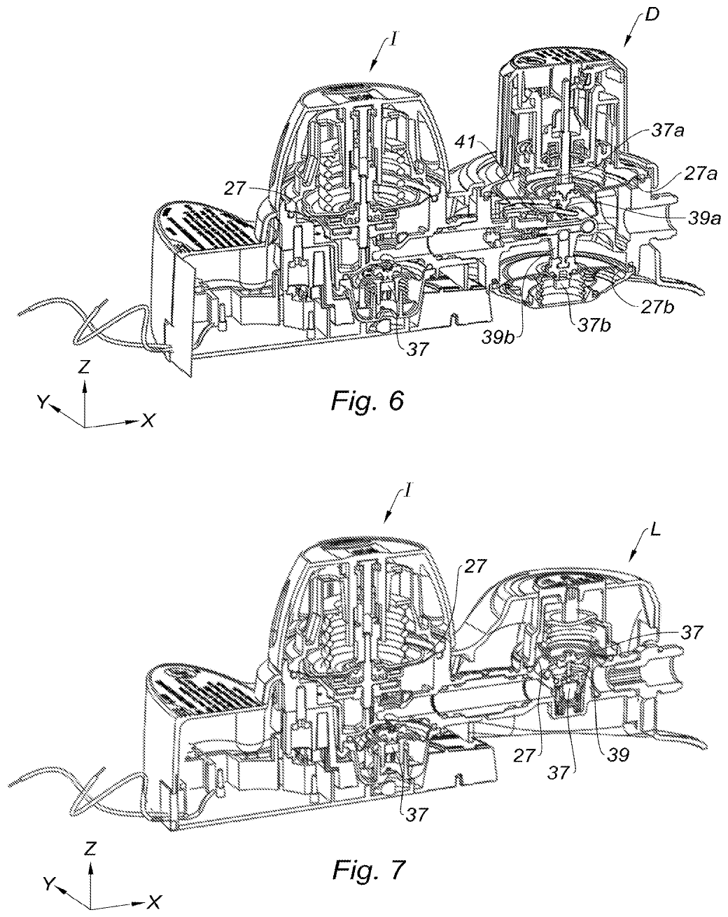

In the example shown in FIG. 6, the regulation assembly according to the present disclosure includes a pressure reducer D in accordance with FIG. 5 and a diverter I coupled upstream of the pressure reducer D.

Unlike the diverter I of FIG. 5, the diverter I of FIG. 6 is of the type including both a gas shut off system in case of over pressure (OPSO system—“Over Pressure Shut Off”) and a gas shut off system in case of under pressure (UPSO system—“Under Pressure Shut Off”). In this case, there are two membranes 27a, 27b and two magnets 37a, 37b, each associated with Hall effect probes (not shown).

In the example shown in FIG. 7, the regulation assembly according to the present disclosure includes a limiter L and a diverter I in accordance with any one of FIGS. 1 to 4 coupled upstream of the limiter L.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A gas supply regulation assembly comprising:
at least one inlet configured to be in fluid communication with at least one gas bottle;
an outlet configured to be in fluid communication with a gas-consuming appliance; and
a gas pressure detection device in a chamber, the chamber in communication with the outlet, the gas pressure detection device comprising a magnetic field measurement device.

2. The assembly according to claim 1 further comprising an automatic diverter comprising:
at least two inlets configured to be coupled to at least two gas bottles;
an outlet configured to be coupled to a gas-consuming appliance; and
an automatic switching device configured to switch a gas supply from a first inlet of the at least two inlets to a second inlet of the at least two inlets when a pressure of the gas supply from the first inlet drops below a predetermined threshold, wherein the first inlet supplies gas from a first bottle of the at least two bottles and the second inlet supplies gas from a second bottle of the at least two bottles.

3. The assembly according to claim 2, wherein the gas pressure detection device comprises a flexible membrane forming a wall of the chamber and adapted to elastically return in a direction of the chamber by a spring, the flexible membrane supporting a cage enclosing a magnet, and the magnetic field measurement device of the gas pressure detection device is fixedly mounted relative to a body of the automatic diverter such that the magnetic field measurement device magnetically interacts with the magnet.

4. The assembly according to claim 2 further comprising a pressure reducer including a second gas pressure detection device.

5. The assembly according to claim 2 further comprising a pressure limiter including a second gas pressure detection device.

6. The assembly according to claim 1, wherein the gas pressure detection device comprises a flexible membrane forming a wall of the chamber and adapted to elastically return in a direction of the chamber by a spring, the flexible membrane supporting a cage enclosing a magnet, and the magnetic field measurement device of the gas pressure detection device is fixedly mounted relative to a body of an automatic diverter such that the magnetic field measurement device magnetically interacts with the magnet.

7. The assembly according to claim 1, wherein the magnetic field measurement device is a Hall effect probe.

8. The assembly according to claim 1 further comprising an electronic communication circuit connected to the magnetic field measurement device and configured to transmits signals that are generated by the magnetic field measurement device.

9. The assembly according to claim 8, wherein the electronic communication circuit is embedded in resin.

10. The assembly according to claim 8, wherein the electronic circuit comprises a wireless communication device and a supply battery.

11. The assembly according to claim 8, wherein the magnetic field measurement device and the electronic circuit are mounted on a plate.

12. The assembly according to claim 11, wherein the plate is attached on a body of the gas supply regulation assembly.

13. The assembly according to claim 1 further comprising a pressure reducer including a second gas pressure detection device.

14. The assembly according to claim 1 further comprising a pressure limiter including a second gas pressure detection device.
